(19) United States
(12) Patent Application Publication
(10) Pub. No.: US 2004/0056478 A1
(43) Pub. Date: Mar. 25, 2004

(54) Safe surgery - surgical safety markers and method

(76) Inventor: Carol Jean Emery Bruce, San Anselmo, CA (US)

Correspondence Address: Thomas W. Cook, Thomas Cook Intellectual Property Attorneys, P.O. Box 1989, 3030 Bridgeway, Suite 425-430, Sausalito, CA, 94965, US

(21) Appl. No.: 10/423,803

(22) Filed: Apr. 25, 2003

Related U.S. Application Data
(63) Continuation-in-part of application No. 10/252,165, filed on Sep. 23, 2002.

(51) Int. Cl. B42D 15/00

(52) U.S. Cl. 283/81

(57) ABSTRACT

A surgical safety device and method is disclosed, utilizing one or more indicators or markers which show a surgeon where to operate, in which the markers are specifically intended to eliminate errors which arise when a surgeon fails to select the correct side for conducting a surgical procedure on his or her bilaterally symmetrical patient, in which such markers positively and unambiguously identify the correct side of the patient upon which to operate, especially when combined in a procedure or protocol requiring the use of two markers.

### CROSS REFERENCE TO RELATED APPLICATIONS

This application is a continuation of application Ser. No. 10/252,165, from which applicant claims priority in part. Applicant has also filed a Disclosure Document Deposit Request, and received file number 51160 for such Request on May 22, 2002.

### TECHNICAL FIELD OF THE INVENTION

The present invention relates to safety devices in the field of surgery, and methods in the field of surgical procedures, utilizing one or more indicators (or “markers”) which show a surgeon where to operate. More particularly, the present invention relates to a new apparatus and process for informing or reminding a surgeon of the correct site or side for cutting during a surgical procedure. Since the surgeon often is well aware of what tissue or organ is to be subjected to a surgical procedure, the elimination of error in such procedures often depends upon identification of the correct side of the patient upon which to operate, as well as the correct site for creating an incision. The present invention is directed to the elimination of such error in surgery, especially the elimination of error which arises when a surgeon fails to select the correct side for conducting a surgical procedure on his or her bilaterally symmetrical patient.

### BACKGROUND ART OF THE INVENTION

The sad fact is that “wrong side” surgeries do, and continue to occur within the medical industry. Surgeons are human beings and can make errors, especially in today's fast-paced and distracted world. While the process of making mistakes is human, and thus understandable, it is not acceptable. Moreover, by way of the simple apparatus and process set forth herein, these mistakes can be eliminated by providing a simple, inexpensive apparatus, consisting of clear warning labels which, especially with a process that will timely inform the surgeon before an error is made, thereby also, and most importantly, protect the unconscious patient from harm.

Currently (and surprisingly!) there is no apparatus or process to avoid operating on the wrong side of the human body. This is particularly problematic because the patient is typically sedated and is thus not in the position to stop the error from occurring. Despite any existing precautions and procedures, mistakes in surgery continue to occur, the most egregious of which is “wrong side surgery.” In most cases, such mistakes could have been prevented if there was a visible mark indicating where to, and most importantly where NOT to, operate (a mistake only occurs by going to the wrong body part to begin with). This recurring problem has not been eliminated even with the use of consent forms, health histories and physicals, modern scheduling procedures, and repeated questioning up to just moments before the patient is put to sleep. It is an awareness of this ‘flaw’ in our current system that fuels this invention, without which these serious injuries will undoubtedly continue to occur.

Apparatus and methods for marking patients preparatory to surgery are common in the prior art. Some such apparatus and methods involve implantable devices, or means for surface marking the location of a biopsy or surgery for the purpose of identification. Such identification often includes information about the patient, the location and type of surgery, and even information specific to the operation at hand. Apparatus which provides such information may even mark a pattern on the skin of a patient to guide a surgeon when, subsequent to such marking, the surgeon incises, or closes a surgical site by suture.

No apparatus or methods for marking the locus of surgery, however, specifically address the danger associated with operating on the “wrong side.” It is in fact not uncommon for a surgeon to discover during or after a surgery is complete that he or she has made an incision at the wrong site or location on a patient, and even removed healthy tissues and organs residing at such sites. The difficulty experienced by surgeons which result in such errors arises out of the bilateral symmetry of most animals, including humans, and the unconscious condition of the patient at the time of surgery.

For example, the surgeon may imperfectly recall the correct site or side of a patient for conducting the operation. When the surgeon addresses the patient in preparation for cutting, he or she may rely on nurses or others to indicate the correct site for surgery. The surgeon has much on his or her mind at such times, and assumptions are made about the location while he or she concentrates on the best approach to surgically deal with the problem at hand. For a further example, the surgeon may well know exactly the site for surgery, and have a correct understanding of which side of the patient requires attention but, because the patent is covered except for the surgical site, the surgeon cannot see the remainder of the patient. As a result, the surgeon cannot orient the patient from external appearance. If the patient is lying supine instead of prone, or prone instead of supine, and the surgeon assumes the incorrect patient orientation, a mistake in the location of surgical site may again be made.

As to the condition of the patient, some procedures have been implemented to prevent errors, one of which is the consent form, which is signed and witnessed. The consent form helps to assure the correct procedure will take place on the correct patient. Consulting the consent form is the last and final check before the patient is brought into the operating room and given general anesthetic under current practice. With such anesthetic, the patient is of course not conscious at the time of, or even immediately before, surgery. The patient, the person closest to the surgery and having the most interest in its successful completion, is therefore unable to oversee the location of the surgical site, and therefore unable to affect the site selection to avoid a site selection which does not match the correct surgical site. Accordingly, the surgeon must rely on his or her self or others present at the time, but cannot utilize the intimate knowledge possessed by the patient to chose the correct surgical site.

In attempting to address risks to the patient, others have attempted to define an area for cutting by various apparatus and methods already mentioned herein. Such apparatus and methods within the prior art include:

U.S. Pat. No. 4,576,163 to Bliss, which discloses a surgical instrument for marking a pattern on the skin of a patient to guide surgery and closure.

U.S. Pat. No. 4,947,867 to Keeton, which discloses labels which may be placed on a patient or gown, which labels bear information about the patent so that the patient receives the correct treatment.

U.S. Pat. No. 5,116,344 to Sundqvist, which discloses an apparatus for marking a predetermined position of a target for surgical treatment within a patient's brain.

U.S. Pat. No. 5,496,304 to Chasan, which discloses an apparatus and method for marking proper surgical locations by injecting a temporary marking agent under the outermost layer of epidermis.

U.S. Pat. No. 5,665,092 to Mandiardi et al., which discloses a surgical marker for accurate marking of tissues under the skin.

U.S. Pat. No. 5,941,890 to Voegele et al., which discloses an implantable surgical marker which is affixed as it grasps tissue. U.S. Pat. No. 5,879,357 to Heaton et al., which discloses a surgical apparatus for marking a location within tissue.

U.S. Pat. No. 6,228,055 B1 to Foerster et al., which discloses implantable surgical devices for imaging a lesion, percutaneously.

U.S. application Ser. No. 09/729,888 to Copelan, which discloses a pre-surgical safety device intended to help avoid surgical procedures from being accidentally performed on patients' unintended body parts.

While the inventions disclosed in these prior patents fulfill their respective objectives, these prior patents do not describe or suggest marking for surgery in such a fashion that a surgeon cannot make the mistake of operating on the wrong side of the patient. These prior marking apparatus are generally directed to the problems of (i) precision in locating a surgical site, (ii) defining a surgical site in size or scope or angle of incision, (iii) fixing a location for surgery if and as a patient is moved (with resultant moving of skin over a surgical site), or (iv) providing guidance for the application of a knife or sutures. The only marking device which deals with surgery at an “unintended surgical site” in any way is that of Copelan. However, Copelan does not directly address “wrong side” surgery or, for reasons which shall become clear below, insure against such error.

Other inventions known in the art are directed to correcting the surgical errors noted herein by marking the side of the patient which is not to be cut, that is, the “mirror image” side of the bilaterally symmetrical patient (the corresponding site on the side across the patient's body from the surgical site). A number of such simple inventions have been developed by practitioners while performing surgery. Such inventions include (i) utilizing a standard office supply red dot sticker (which practice is not common because, the sticker falls off the patient and leaves residue which interferes with surgery), (ii) signing the surgical site by the surgeon in temporary ink (which practice is not common because the ink washes off the patient before surgery), and (iii) signing the surgical site by the surgeon in permanent ink (which practice is not common because the ink interferes with the surgeon's view of the surgical site during surgery).

All such indicators are of course better than not using indicators, and marking for correct siting of the surgery is common. The Joint Commission of Accreditation of Healthcare Organizations has, for instance, advised patients to insist that the surgeon mark the “involved area,” preferably with an indelible pen and in full view of the patient. While the meaning of this practice statement is unclear, the meaning attributed to this statement in the field of surgery is that one should mark the correct surgical site, the site scheduled for surgery. The Joint Commission goes on to recommend that patients mark the involved areas themselves, and show that area to the surgeon, as an even better alternative.

The present invention directly addresses “wrong side” surgery risks with a “wrong side” indicator comprising words, pictures and symbols, such as the international symbol for “no” or “don't.” Such indicators may be used in combination with words such as “wrong side,” or such words may be used alone without any graphic components. This “wrong side” indicator may be in the form of decals designed to stick to a body part for a few hours or a few days. Such decals are applied by removing a plastic covering, touching the decal to the body part needing protection, and dabbing a wet paper towel to its top surface until it is saturated, whereupon the paper backing may be lifted off, leaving a clear and bright indication against incision at that site. The patent to Copelan, as noted above, takes a different approach in supplying “warning strips” which alert a surgical health care provided that “they are not at the intended surgical site.” However, Copelan does not specifically address “wrong side” surgery (nor does Copelan even acknowledge errors in surgery arise from the bilateral symmetry of a patient). More importantly, Copelan describes a warning strip, but does not identify how such a strip accomplishes its warning function. This is an important point, as most indicia intended to covey a message that a surgeon is at the wrong site is ambiguous. While the indicia of Copelan is, according to Copelan, “instantly recognizable,” Copelan does not teach unambiguous messages, or any message about wrong side surgery. Moreover, to be usable with a patient who is about to go to surgery, the indicia employed should also avoid upsetting the patient, a result which is likely when using “instantly recognizable” indicia depicting knives as Copelan does (regardless of the purpose of the indicia of Copelan).

For a variety of reasons, all such apparently “foolproof” procedures, like that of the Joint Commission, and apparatus, like that of Copelan, do not unambiguously indicate which side of the patient is the correct side for the surgical procedure every time. The reasons for continued error when using surgical indicators include, but are not limited to:

(i) the indicator identifies a site which should not be cut, but does not identify that side as being on the “wrong side,” or there is no guidance or mandatory procedure requiring placement of an indicator at any particular site.

(ii) the indicator is placed on the patient by a nurse or other health professional prior to surgery, rather than the patient, resulting in an error because such professional does not know the correct site, or is distracted, or simply suffers from a form of dyslexia, a condition much more common than is generally recognized.

(iii) the “wrong side” indicator is not always placed on a patient before surgery, resulting in a situation in which the surgeon assumes he or she has the right surgical site because no “wrong side” indicator appears, and he or she does not check the other side which should have an indicator but doesn't.

(iv) the indicator, such as the “X” which appears in the materials of the Joint Commission of Accreditation of Healthcare Organizations, is ambiguous (an “X” being consistent with “don't operate here” or “X marks the spot for surgery”).

(v) the indicator is not used at all, because indicia which depicts knives or other implements is upsetting to a patient, when used in a way which acknowledges errors in surgery are possible.

The present invention overcomes the drawbacks of prior inventions, including warning strips, by a variety of means, including:

(i) each marker or label of the present invention displays indica which is unambiguous in its message,

(ii) each marker or label of the present invention displays indica which is calculated to put a patient at ease as much as is possible in light of the position in which the patient finds himself or herself,

(iii) the patient is preferably enlisted in the surgical site selection process, as the patient has the keenest interest in a correct surgical site selection,

(iv) two labels are used in some embodiments of the present invention to eliminate the risks inherent in inconsistent application of a single label, and

(v) a procedure is provided in one embodiment of the present invention which specifically identifies a “wrong side” by reference to the correct surgical site.

By utilizing these features, and other features set forth below, one can eliminate errors of “wrong side” surgery resulting from bilateral symmetry of the patient. The surgical markers of the present invention, when incorporated into hospital protocol, allow a surgeon to conclude immediately, and despite the haste and distractions of the surgical room, and through the surgeon's concentration on the procedure to be used, that the site the surgeon has before him or her is, because it is not marked, at least questionable. The surgeon, and everyone else who prepares a patient for surgery, also has immediate confirmation of the correct site when he or she checks the other side of the patient after discovering the wrong site.

### DISCLOSURE OF INVENTION

### SUMMARY OF THE INVENTION

In its simplest form, this invention is a label or other marker utilizing bold unambiguous words, logos, or symbols, and, in most embodiments, methods to help keep the label visible before and during surgery. The label may consist of a printed logo on surgical tape, or a decal, or a printed sign on a soft adjustable strap (for sensitive or allergic patients). This label is intended to mark the patient's non-operative site, so as not to interfere with the surgeons' scope of practice. This present “Safe Surgery” label and system has been designed for the sole purpose of alerting the surgeon that he or she is on the “wrong side” of the body so he or she can quickly move to the correct side, preventing a terrible error, (an error that is somewhat underestimated by the general public). In this application the incorrect site for surgery, i.e. the site which “corresponds” to the correct surgical site, but is directly across the bilaterally symmetrical body of the patient, will generally be called the “wrong side” site, or the “wrong side site.”

More specifically, the present “Safe Surgery” invention overcomes the problems and disadvantages of the prior art by utilizing a marker, the “wrong side market,” which unambiguously identifies the wrong side site. In one preferred embodiment, the marker is also supplied with indicia which is not scary or upsetting to the patient. In a further refinement of the present invention, a process or protocol is identified which, when used with the unambiguous wrong side marker, nearly eliminates all wrong side surgery. In a further embodiment of the present invention, at least two markers are used, which markers show all concerned with the surgery which site is the correct surgical site and which site is the wrong side site.

When used with the steps set forth herein, which steps are utilized with markers of the present invention prior to and during surgery, all wrong side surgical errors may be eliminated. In this last preferred embodiment of the present invention, the markers may be in the form of (i) a sticker, a temporary tattoo, a decal, or a length of surgical tape, any of which materials may be applied directly to (or more likely at an established distance and/or direction from) the intended surgical site, to indicate the correct place for the surgeon to cut, and (ii) a complimentary sticker, temporary tattoo, decal, or length of surgical tape which may be applied to the corresponding wrong side site on the other side of the patient's body, and (iii) a process or protocol for applying both the correct surgical site marker and the wrong side site marker. The markers may also consist of printed signs on an adjustable strap which may be wrapped around the body part which will be subjected to surgery, and a complimentary strap with printed sign which may be wrapped around the corresponding wrong side site on the other side of the patient's body, along with the same or similar protocol.

The markers of the present invention may be applied directly to the correct site and the corresponding wrong side site as noted above, or to the wrong side site only. In one preferred embodiment, the markers are applied near or around the correct surgical site, or at an established distance and/or direction from such site, and on or near the “wrong side” site. The reason for placing the markers near or around the correct site is, of course, that a sterile field must be created and maintained at the surgical site, and such sterile field is more difficult to create and maintain if other objects, even markers such as those of the present invention, are placed within the sterile field. Thus, one preferred embodiment of the present invention envisions at least one marker for the correct surgical site, and at least one marker for the wrong side site (along with the specified procedure), but two or more markers may be used on either side of the patient to good effect under some circumstances.

Most of the benefits of the present invention arise out of the simple expedient of using at least one marker, a “negative marker,” as set forth herein. However, the character of the marker, and the indicia found thereon, may also contribute to a quick and clear and, most importantly, unambiguous, identification of the correct surgical site and the wrong side site. Thus, for instance, a hand held up on a “hold” position, as seen in the drawings submitted herewith, the color red, words such as “wrong side” or “not this side” or “go to the other side” or “precious part” or “no sharp objects” or “don't touch me here,” and other unambiguous “negative” indicia, may each be helpful to the surgeon, to indicate the spot he or she is looking at is the wrong side site. Similarly, the color green, a check mark, or words such as “OK to operate” or “fix this,” and other unambiguous “positive” indicia, may more clearly indicate the correct surgical site than other terms. Certain indicators, such as “go,” are inappropriate for the correct site, since go is ambiguous (meaning, perhaps, “go away” or, alternatively, “go for it!”). Yet other indicators do not say or imply that a site is a wrong side site, or they are frightening to a patient. Words such as “do not cut” are unacceptable for this reason alone. In one preferred embodiment of the present invention, a hand, the color red, the international symbol for “stop” (circle with diagonal cross bar), and the words “wrong side, doc” all are used to mark the wrong side site. However, all such indicia, whether indicating the correct surgical site (by positive indicia, creating a “positive marker”) or the wrong side site (by negative indicia, creating a “negative marker” which is unambiguous, or non-frightening, or both), and whether used singly or in combination, are encompassed by the present invention.

In one preferred embodiment of the apparatus of the present invention, the markers comprise lengths of thin, adhesive-backed plastic tape designed to hold indicia consisting of words and graphics. Such tape is generally hospital grade, and of a size to be immediately noticed by a surgeon, generally about two inches square. However, the size of the markers may be varied, and the shape of the markers may be varied, to accommodate the size and shape of various body parts and body sizes. Such tape may be placed on a backing, and a tape pull tab formed in the tape to help with separation of the tape from such backing. Such tape is generally smooth on its top surface, and equipped with adhesive to facilitate adhesion to the backing and to the patient upon use. Such tape may also be furnished with a protective, peel-away cover to protect the smooth surface of the marker against damage, discoloration, or marring. Such cover will generally be clear or translucent to show the character of the underlying message, and so facilitate selection of the proper marker for the proper purpose. However, it may also simply on its top duplicate the message of the underlying marker, to provide the same information as the underlying marker for the same purpose.

The positive marker in one preferred embodiment consists of such tape upon which is displayed unambiguous, positive indicia, while the negative marker in the same preferred embodiment consists of such tape upon which is displayed unambiguous, negative indicia. In one preferred embodiment, the positive and negative markers are intended to be used in pairs, and so a pair of markers (both positive and negative) are supplied for use with each prospective surgery. Thus, the positive and negative markers may be supplied individually, however most preferred embodiments of the present invention anticipate both positive and negative markers supplied as a set, often in the form of both markers residing on a single backing piece, or as separate markers removably joined to one another.

In a second preferred embodiment, the positive and negative markers of the present invention may be provided in the form of decals, or “temporary tattoos.” In such embodiment, the markers are printed with positive and negative indicia as with other embodiments, and the indicia appears on the markers with the same clarity as any paper or printed adhesive label. With such embodiment, the positive and negative markers may be decals designed to stick to a body part three to four days. As with decals used for other purposes, the decals of the present invention are applied by removing their plastic coverings, touching the decals to the body parts consistent with the process of the present invention, and dabbing a wet paper towel to the top surfaces of the decals until the marker is saturated, whereupon the paper backing may be lifted off, leaving clear and bright instructions to the surgeon consistent with the messages of the markers when properly applied. As decals, the markers of this second preferred embodiment appear and act very like the adhesive tape label of the first preferred embodiment, but the second preferred embodiment has the distinct advantage of being ideal for use with those patients having tape or adhesive allergies.

Whether the present invention is in the form of tape, stickers, or decals, preferred materials include those which do not induce allergic reactions (hypoallergenic materials), including hypoallergenic inks in decals where the ink may come in contact with the skin of a patient, and materials which are latex free. By use of such materials and inks, use of the markers of the present invention does not induce or aggravate adverse reactions in patients who are, or may become, sensitive to some commonly used materials.

In yet other preferred embodiments, the markers of the present invention may be stored and supplied in a single reel of tape or decals, positive and negative markers alternating along the reel, or placed side by side on the reel, so that a user may conveniently use the positive and negative markers in pairs. In the alternative, the positive and negative markers may be placed on separate reels and the reels joined or placed close to one another. In all such schemes for storing and supplying, the underlying materials of the reel may be perforated, so that individual markers (or pairs of markers) may be easily separated from the main body of the reel, or individual markers (or pairs of markers), with their backings, may be removably affixed to one smooth surface of the reel by adhesive, static cling, or other known means. In the above preferred embodiments, the adhesive may be of a type standard for surgical tape or decals, however a preferred adhesive for use with such embodiments is adhesive designed to stick for a specified period of time, or adhesive which may allow release of the label on application of water or other solvent. In one embodiment, the adhesive of the present invention may release automatically at 24 hours, or other time found desirable in light of the time necessary after application to complete surgery (as for instance, with a time-release adhesive lasting only three hours, where the marker is applied just prior to surgery). In all such cases, the preferred adhesive, like the markers themselves, should be hypoallergenic and latex free.

In another preferred embodiment of the present invention, the markers may be affixed to, or impressed on soft, adjustable bands using adhesive materials with trade names such as VELCRO™ or self adhering qualities like COBAN™. With such an embodiment, the markers of the present invention may be easily applied to the proper sites on a patient, and removed from the patient without pulling the patient's skin (as tape does), or obscuring the details of a decal-like marker (as wrinkly skin might). Such bands would hold printed markers or indicia (on durably thick paper or printed right on the bands) with the same bold words, graphics and/or symbols needed to catch the attention of the surgeon. It may be appreciated that such bands may be used to indicate the correct side, without obscuring the surgical site, while at the same time protecting the opposite, wrong side site, as the negative marker, such as “wrong side Doc,” is also used. In some instances, the wrong side label or band markers may be formed in such a fashion to entirely cover the wrong side site, or the wrong body part as a whole.

In all preferred embodiments of the present invention using two or more labels, the benefits of the wrong side label or band remains throughout the surgery, even if the decal or tape of the correct surgical site is removed before the surgical preparation or wash.

The operating room within the hospital setting presents those working in it with unusual challenges, as different rooms face different directions, beds face different directions within the rooms, doors enter the rooms from the left or right sides of the operating table, and the orientation or position of the patient changes from operation to operation (from face up to face down, head or feet to one end or the other of the operating room or operating table, etc.) Presently, there is no policy, procedure, or device to keep a surgeon from incorrectly identifying the patient's left side from the patient's right side once the patient is lying on the operating room table. Yet, it is acceptable to place a mark anywhere on the body of the patient so long as such mark does not adversely affect the operative site (by destroying the sterile field, obscuring the surgeons view, or for other reasons).

The surgical consent form informs the surgical team which body part is to be operated on. It is only under the unfortunate circumstance of an error in locating the correct site for surgery that the wrong limb or body part is uncovered, and a mistake can occur. Nevertheless, because of the difficulties in orientation noted above, such error and mistake takes place in the operating room with surprising frequency. With markers such as those of one preferred embodiment of the present invention, any nurse or doctor in the operating room must spot one of the two required markers of that preferred embodiment. As a matter of routine or established procedure or “protocol” (collectively, the “process” or “method” of the present invention) such person may discover a wrong side marker, cover up the wrong side site, re-check the surgical consent, confirm the correct limb or other body part with the surgical team, and proceed to the correct side and site. Such markers, especially when used with the process of the present invention, prevent any lucid surgeon from accidentally operating on the wrong side; disaster is quietly (and routinely) avoided.

In a preferred process of the present invention, the above benefits are achieved primarily by use of both positive and negative markers on the patient, at or near the surgical site, and at the corresponding opposite wrong side site, before an incision is made in the patient. However, the benefits of the process of the present invention should be incorporated into usual hospital procedure as a protocol to insure against wrong side surgical error. Thus, a protocol may be established in a hospital using the markers of the present invention as follows:

a. A medical professional may select a negative marker from a stock of such markers kept at a convenient location in the hospital. Such convenient location is preferably where the patient resides the night before surgery, for early application of markers, however the markers may also be stored for use in ambulatory surgery, to be applied the morning before surgery, or even in the operating room for last minute application.

b. A medical professional may then select a positive marker from a similar stock of such markers, preferably kept at the same convenient location in the hospital as that used for the negative markers. Of course, the order for selection of positive and negative markers may be reversed or, preferably, the positive and negative markers are selected at the same time.

c. A medical professional may then hand the positive marker to the patient, and instruct the patient in the use of the marker, to encourage patient involvement in the correct surgical site identification.

d. A patient may then peel off the positive marker, and place it just above the operative site, or at a distance or in a direction established by hospital protocol as directed by the medical professional.

e. A medical professional may then confirm the site selected by the patient against the signed surgical consent,

f. A medical professional may then apply a negative marker to the opposite, wrong side site, with instructions to the patient and others that the negative marker cannot be removed until after the surgery.

g. A medical professional may then uncover the wrong side site in the operating room during preparation for surgery on the patient, thereby showing and observing the negative marker previously applied to the patient.

h. A medical professional may then cover up the wrong side site of the patient in the operating room.

i. A medical professional may then re-check the surgical consent of the patient.

j. A medical professional may then confirm the correct limb or other body part with the surgical team.

k. A medical professional may then proceed to the correct side and the correct surgical site on the patient.

l. A medical professional may then uncover the correct surgical site in the operating room during preparation for surgery on the patient, thereby showing and observing the positive marker on the patient.

m. A medical professional may then prepare the patient for surgery in the usual way.

n. A surgeon may then observe the positive marker on the patient, thereby indicating the correct surgical site, or not observe the positive marker if the protocol is to remove the positive marker during surgical preparation.

o. A surgeon may then begin the surgical procedure with confidence that the locus of the incision on the patient is on the correct side of the patient, and therefore is the correct surgical site.

Where different embodiments of the apparatus of the present invention are used, appropriate adjustments may be made to the procedure noted above. For instance, where markers in the form of soft self-adhering bands are used as alternative markers for sensitive skin, the patient may place the band with the positive marker on or near the correct surgical site (if he or she is able), or indicate the correct surgical site for the medical professional to place the band, and the medical professional may then place the band in the appropriate position near the correct surgical site. The medical professional may then continue with the above procedure, beginning with the step of confirming the site selected by the patent is the correct surgical site, and continuing with the step of placement of the wrong side site (negative) marker as set forth above. In the alternative, a surgeon or other designated individual may himself or herself place the positive and negative markers on the correct and wrong side sites with or without consulting the patient. All such variations on the procedure set forth above are included within the procedure of the present invention.

The present invention may also be used to good effect in the application of anesthesia prior to and during surgery, or for any other medical purpose where certainty against performing a procedure on the wrong side is important. In the case of anesthesia, for instance, certain types of surgery require the application of anes to relatively large portions of the body, without rendering the patient unconscious. Under these circumstances, an error in applying anes in which the professional anes the wrong side of the patient may prevent a surgery from taking place on the scheduled day, because the patient cannot accept anes to the other side of his body within the time allotted for the surgical procedure without unreasonably risking the patient. Moreover, anes the correct side of a patient prior to surgery may be critical to the patient, because a mistake in anes the wrong side of the body of a patient may be carried into the surgical procedure as the surgeon and others assume the anes was correctly applied, and so operate on the wrong side because of the prior error in anes.

In the case where the markers and methods of the present invention are employed to prevent errors in anes, most embodiments of the markers are useable without modification, as the indicia on the markers do not specifically refer to “cutting” or “surgery”; the markers are designed not to create fear arising from use of such words. The methods of the present invention are also usable to insure against error in anes, again almost without modification, however in some circumstances these methods may be varied consistent with usual anesthetic practice.

The more important features of the invention have thus been outlined, rather broadly, so that the detailed description thereof that follows may be better understood, and in order that the present contribution to the art may be better appreciated. Additional features of specific embodiments of the invention will be described below. However, before explaining preferred embodiments of the invention in detail, it may be noted briefly that the present invention substantially departs from pre-existing apparatus and methods of the prior art, and in so doing provides the user with the highly desirable ability to insure surgery is conducted only on the correct side of a bilaterally symmetrical patient, and so at the correct surgical site.

### OBJECTS OF THE INVENTION

A principal object of the present invention is to promote surgery on a patient at the correct surgical site.

A further principal object of the present invention is to reduce errors in surgery arising out of confusion about which side of a bilaterally symmetrical patient is the correct side for surgery.

A further principal object of the present invention is to provide at least one unambiguous, non-frightening marker, which may be used to reduce the likelihood of wrong side surgery.

A further principal object of the present invention is to provide markers which unambiguously indicate both the correct surgical site and the wrong side site, thereby further reducing the probability of error resulting from wrong-side surgery.

A further principal object of the present invention is to provide a procedure for use with the markers of the present invention, or any similar markers, which procedure insures against wrong-side surgery.

### BRIEF DESCRIPTION OF DRAWINGS

The accompanying drawings, which are incorporated in and constitute a part of this specification, illustrate three embodiments of the present invention, and such drawings, together with the description set forth herein, serve to explain the principles of the invention.

FIG. 1 is a plan drawing of one preferred marker of the present invention, which shows the negative indicia of such negative marker of the invention. FIG. 1 also shows a cross section of the same negative marker.

FIG. 2 is a plan drawing of an additional marker of the present invention, which shows the positive indicia of such positive marker of a second embodiment of the invention, which marker is intended to be used in conjunction with the negative marker shown in FIG. 1 (or similar marker consistent with this invention). FIG. 2 also shows a cross section of the same positive marker.

FIG. 3 is a plan drawing of a third embodiment of the apparatus of the present invention, which shows both the positive and the negative indicia of both a positive marker and a negative marker of the invention.

FIG. 4 is a flow chart diagram of the method of the present invention when using the apparatus of any preferred embodiment set forth herein.

### DETAILED DESCRIPTION OF PREFERRED EMBODIMENTS

### Apparatus of the Invention

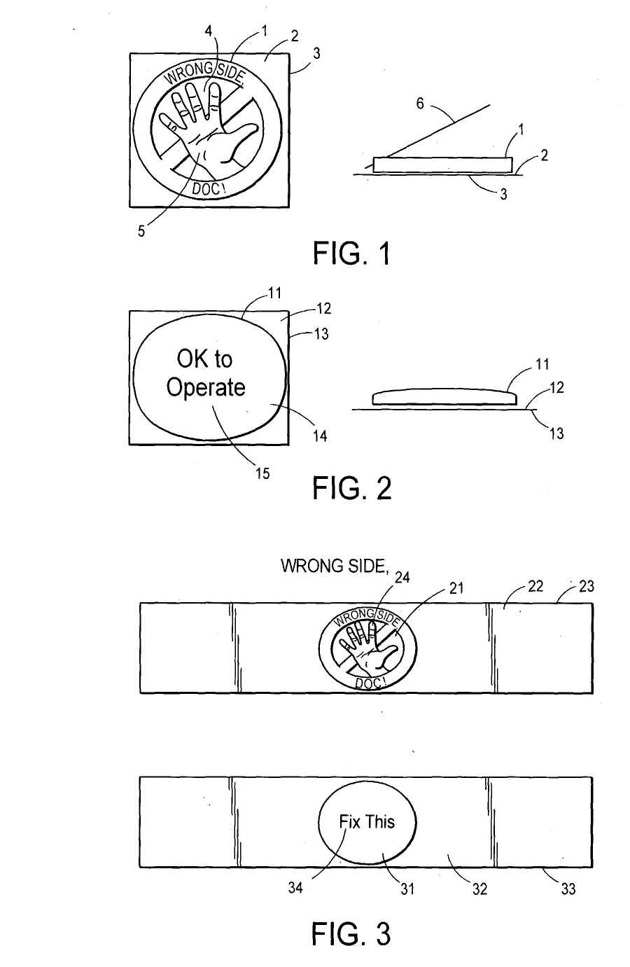

Referring initially to FIG. 1, a first embodiment of the present invention is shown in plan view and in cross section. In FIG. 1 a negative marker 1 resides on the smooth surface 2 of paper backing 3. The negative marker 1 is affixed to the smooth surface 2 of the paper backing 3 by means common in the sticker industry, or by means of an adhesive which may be designed to self release after a specified time, generally within 36 hours, or with the application of common solvents such as water. From its position on the paper backing 3, the negative marker 1 may be easily peeled from the smooth surface 2 of the paper backing 3 and affixed to or near the wrong side (incorrect) site on the patient (not shown). The wrong side site is the site across from the correct site when a patient is considered as a bilaterally symmetrical animal. Put another way, the wrong side site is the same site as the correct surgical site, except the wrong side site is the corresponding site on the other, mirror image, side of the patient.

In FIG. 1, the marker 1 displays on its surface 4 negative indicia 5, in this embodiment the words “WRONG SIDE, DOC,” a hand held in “stop position,” and the international symbol for “NO.” FIG. 1 also shows a cross section of the same negative marker, in which negative marker 1 resides on the smooth surface 2 of paper backing 3. The cross section negative marker drawing of FIG. 1 also shows an optional cover sheet 6, used to protect the negative marker 1 from mechanical damage, fading, or mutilation. The apparatus of FIG. 1 may be used alone, in one preferred embodiment, or as a first part in combination with a second part of a (second) two-part preferred embodiment, the second part of which is (or is like) that shown in FIG. 2.

Referring now to FIG. 2, a second component of one preferred embodiment of the new apparatus of the present invention is shown in plan view. In FIG. 2, a positive marker 11 resides on the smooth surface 12 of paper backing 13. The positive marker 11 is affixed to the smooth surface 12 of the paper backing 13 by means common in the sticker industry, or by means of an adhesive which may be designed to self release after a specified time, generally within 36 hours, or with the application of common solvents such as water. From its position on the paper backing 13, the positive marker 11 may be easily peeled from the paper backing 13 and affixed to or near the correct surgical site on the patient (not shown). The marker 11 displays on its surface 14 positive indicia 15, in this embodiment the words “OK to Operate.” FIG. 2 also shows a cross section of the same positive marker also shown as a plan drawing in FIG. 2, in which positive marker 11 resides on the smooth surface 12 of paper backing 13. The apparatus of FIG. 2, to be effective, should be combined as a second, complementary part of a two-part preferred embodiment with a negative marker such as that shown in FIG. 1.

Referring now to FIG. 3, a third preferred embodiment of the present invention is shown in plan view. In FIG. 3, a negative marker 21 resides on the smooth surface 22 of thin adhesive backed plastic tape 23 designed to hold negative indicia 24 like that found in FIG. 1. Such tape is generally hospital grade, and of a size to be immediately noticed by a surgeon. In the alternative, negative marker 21 may be printed on the smooth surface 22 of thin adhesive backed plastic tape 23. FIG. 3 shows both the negative indicia 24 of negative marker 21, and the positive indicia 34 of positive marker 31 on the smooth surface 32 of a second strip of adhesive backed plastic tape 33.

In yet another alternative embodiment, the positive and negative markers may be used with soft adjustable bands. Referring to the same plan view of FIG. 3, then, negative marker 21 may reside on, be affixed to, or impressed on the surface 22 of soft, adjustable bands 23, while positive marker 31 may reside on, be affixed to, or impressed on the surface 32 of soft, adjustable band 33. Using such materials, the markers of the present invention may be easily applied to the proper sites on a patient, and removed from the patient without pulling the patient's skin (as tape does), or obscuring the surgical site as a decal-like marker might. Such bands would hold printed markers or indicia (on durably thick paper or printed right on the bands) with the same bold words, graphics and/or symbols needed to catch the attention of the surgeon as those found in FIG. 1 and FIG. 2. It may be appreciated that such bands may be used to indicate the correct side, without obscuring the surgical site, while at the same time protecting the opposite side (the wrong side site) as the negative marker, such as “wrong side Doc” is also used at the latter site. The size of the markers may be varied, and the shape of the markers may be varied, to accommodate the size and shape of various body parts and body sizes, regardless of the embodiment chosen or the materials used.

### Process of the Invention

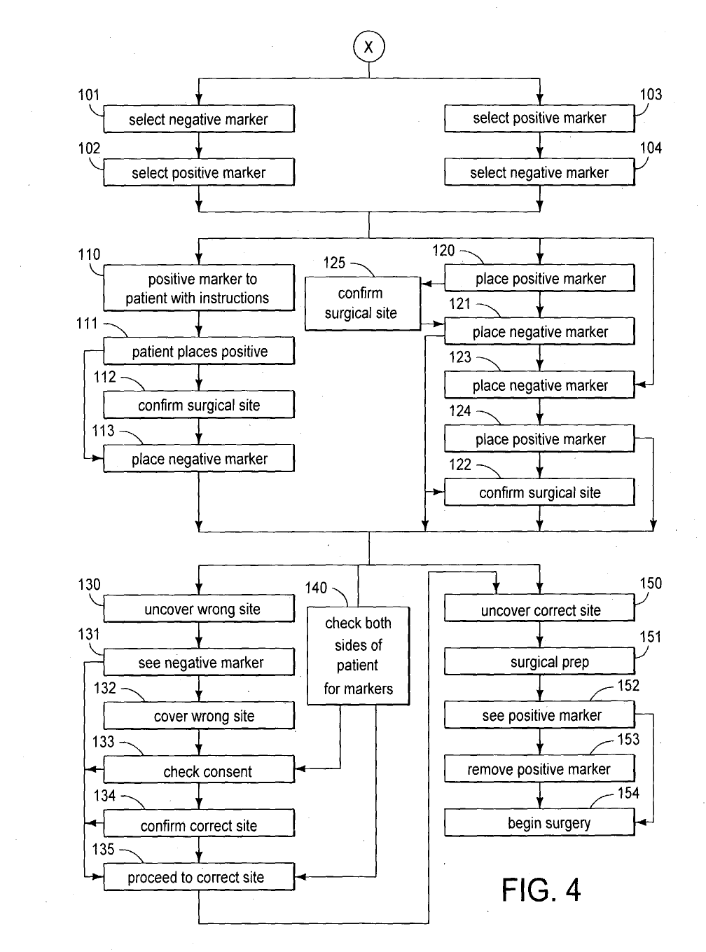

Referring now to FIG. 4, a flow chart which schematically represents the process which is a principal feature of the present invention. In FIG. 4, a preferred embodiment of the present safe surgery invention process is comprised of a series of steps, each of which step is represented by a rectangular box. The order of these steps is represented serially by the direction of the arrows between the steps. Thus, one step may be seen to be the step of selecting a negative marker. Immediately thereafter another step is taken, and so on, until the safe surgery process is complete.

In the steps of FIG. 4, the user begins the process at the point labeled “X.” Beginning at “X,” a medical professional (or “user”) first selects a negative marker 101 from a stock of such markers kept, as noted above, at variety of convenient locations in or near a surgical room or hospital. The user then selects a positive marker 102, generally from the same stock. Of course, the order for selection of positive and negative markers may be reversed, such that a positive marker is selected 103 and then a negative marker is selected 104.

After marker selection, the user may then hand the positive marker to a patient intended for surgery 110 while instructing the patient in the use of the marker. The purpose of engaging the patient in this process is to encourage patient involvement in the correct site identification. A patient may then peel the positive marker off of its backing, or grasp a flexible band bearing the positive indicia, and place the positive marker or band just above the operative site 111, or as directed by the medical professional. It should be noted here that the medical professional user may check for proper placement of the positive marker at a number of points in this process with good effect, from checking such placement prior to marker selection, to checking such placement immediately prior to the first surgical incision. However, some points in the process are logically better than others for this check, the better points providing a check on a choice just made (but prior to incision). One such better point in the process for checking placement of markers is to confirm the site selected by the patient against the signed surgical consent 112 immediately after placement of the positive marker by the patient 111. After confirmation of the surgical site 112, or after placement of the positive marker by the patient 111 if such confirmation is not performed, the medical professional may then apply a negative marker 113 to the opposite, or wrong side site. With such placement of the negative marker, the patient is then also generally instructed that the negative marker cannot be removed until after surgery. The patient may then proceed to the operating room for surgery.

In the event the patient is unconscious when the positive and negative markers are placed, of if a medical professional determines there is some other reason why the patient should not or cannot be involved in the surgical site selection process, the user may then place the positive marker on the patient 120, place the negative marker on the patient 121, and confirm the surgical site 122. The user may of course reverse the placement of markers, placing the negative marker 123 first, placing the positive marker 124 second, and then confirming the surgical site 122. The best course, however, is that course which is most likely to avoid confusion when consistently applied. Thus, the best course is to first place the positive marker 120, confirm the surgical site 125, and then place the negative marker 121. The user may then again confirm the surgical site 122, or allow the patient to proceed to the operating room.

In the operating room, the user may uncover the wrong side site 130 during preparation for surgery on the patient, thereby showing the negative marker. When the user sees the negative marker 131, the user is alerted to a possible error, whereupon the user may cover the wrong side site 132, re-check the surgical consent 133, confirm the correct limb or other body part with the surgical team 134, and proceed to the correct side and the correct surgical site 135.

The above procedure is directed to those few cases in which the wrong side site is uncovered first. In such cases, the above procedure will prove highly valuable. Of course, proceeding to the correct surgical site directly, without first uncovering the wrong side site, is probable. However, the probability of proceeding directly to the correct surgical site is greatly increased if the user first checks both sides of the patient for markers 140, and confirms the presence of both a positive marker and a negative marker. The user may then re-check the surgical consent 133, confirm the correct limb or other body part with the surgical team 134, and proceed to the correct side and the correct surgical site 135 as set forth above, or proceed directly to the correct surgical site 135 immediately.

However the surgical team comes to correct surgical site, the user may then uncover the correct surgical site 150, and prepare the patient for surgery 151. In the process of such preparation, the surgical team, and likely also the surgeon conducting the operation, will observe the positive marker 152, thereby confirming to all who are interested that the correct site lies before them. The surgeon may also not observe the positive marker if the protocol is to remove the positive marker during surgical preparation, however the better course is for the surgeon to personally see the positive marker 152 before cutting. At this point the user or the surgeon may remove the positive marker 153, or leave it in place because it was placed so as not to impede the surgeon, and begin the surgery 154 with confidence that the locus of the incision is on the correct side of the patient, and therefore is the correct surgical site.

Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. An apparatus for marking a patient before surgery, comprising:
a positive marker having positive indicia;
means for affixing the positive marker to a patient;
a negative marker having negative indicia; and
means for affixing the negative marker to the patient.

2. The apparatus for marking a patient before surgery of claim 1, in which the positive marker and the negative marker are each stickers.

3. The apparatus for marking a patient before surgery of claim 1, in which the positive marker and the negative marker are each decals.

4. The apparatus for marking a patient before surgery of claim 1, in which the positive marker and the negative marker are each bands.

5. An apparatus for marking a patient before surgery, comprising:
a negative marker having unambiguous negative indicia; and
means for affixing the negative marker to the patient.

6. The apparatus for marking a patient before surgery of claim 5, in which the negative marker is a sticker.

7. The apparatus for marking a patient before surgery of claim 5, in which the negative marker is a decal.

8. The apparatus for marking a patient before surgery of claim 5, in which the negative marker is a band.

9. A method for marking a patient before surgery, comprising the steps of:
selecting a positive marker and a negative marker for affixation to a patient;
handing the positive marker to the patient, with instructions to the patient to affix the positive marker to the patient near the intended surgical site;
confirming the site selected by the patient for affixation of the positive marker is the correct surgical site; and
placing a negative marker on the corresponding wrong side site of the patient on the other side of the patient's body.

10. The method for marking a patient before surgery of claim 9, further comprising the step of checking both sides of the patient for the presence of both a positive marker and a negative marker.

11. The method for marking a patient before surgery of claim 9, further comprising the step of checking the site intended for surgery in an operating room for the presence of either a positive marker or a negative marker.
